(19) United States
(12) Patent Application Publication
(10) Pub. No.: US 2004/0210482 A1
(43) Pub. Date: Oct. 21, 2004

(54) Gift certificate, gift certificate, issuing system, gift certificate using system

(76) Inventor: Tetsuhiko Keneaki, Ashiya-shi (JP)

Correspondence Address: RATNERPRESTIA, P O BOX 980, VALLEY FORGE, PA, 19482-0980, US

(21) Appl. No.: 10/823,527

(22) Filed: Apr. 13, 2004

(30) Foreign Application Priority Data
Apr. 16, 2003 (JP) 2003-111128

(51) Int. Cl. G06F 17/60; G06F 7/08

(52) U.S. Cl. 705/14

(57) ABSTRACT

A purchaser of a gift certificate registers a paying method, a using condition, a password, and a delivery target in a server, using a terminal. The server (issuer) issues the gift certificate that has no face value, a gift certificate number as a specific code, and the using condition, and sends the gift certificate to a registered user. The user who received the gift certificate, in buying a commodity in a store, logs in to the server from a terminal for the store, and inputs the gift certificate number and information of the bought commodity. The server requests input of a password, and, when the correct password is input, makes payment of the commodity by the registered paying method.

### BACKGROUND OF THE INVENTION

1. Field of the Invention

The present invention relates to a gift certificate, and an issuing system, a using system, an issuing method, and a using method of the gift certificate, and more specifically to a gift certificate having no specified face value, an issuing system thereof, and a using system as a paying method thereof.

2. Background Art

A gift certificate generally means an unregistered, fixed-amount, and valuable security exchangeable for a commodity. The gift certificate can be used for purchasing a commodity carried by a gift certificate issuing store within an amount described thereon. The gift certificate is designed to be presented to another person, and various designing ideas are considered. Such a gift certificate is disposed in Japanese Patent Unexamined Publication No. 2001-167205, for example. A person (purchaser) that intends to present the gift certificate arbitrarily sets the design, words to be entered in the gift certificate, an available store, or a face value, and prepares a so-called made-to-order gift certificate. A person (user) that received the gift certificate exchanges the gift certificate for his/her desired commodity in a store where the gift certificate is allowed to be used. The store that sells the commodity and receives the gift certificate shows the gift certificate to an issuing company and receives face value money.

In this structure, however, when a purchaser intends to present a specific commodity, for example a satchel (school bag), a user buys a commodity within a face value indicated on the gift certificate, or buys a commodity of which price exceeds the face value by paying additional money. When the price of a desired commodity is lower than the face value, the user throws excessive amount away or buys an undesired commodity.

Most gift certificates can be used freely within the face value, and a user can use a gift certificate for buying a commodity unintended by the purchaser.

### SUMMARY OF THE INVENTION

A gift certificate of the present invention has no face value but has a specific code, and the code indicates a paying method. A gift certificate issuing system of the present invention has a display unit, an input unit, a holding unit, and an issuing unit. The display unit indicates a screen used for inputting items required for use of a gift certificate. The input unit receives an input based on the indication by the display unit. The holding unit captures the items inputted into the input unit. The issuing unit issues a gift certificate based on the items captured by the holding unit. A gift certificate using system of the present invention has a display unit, an input unit, a holding unit, and a paying unit. The display unit indicates a screen used for inputting items required for use of a gift certificate. The input unit receives an input based on the indication by the display unit. The holding unit captures the items inputted into the input unit. The paying unit executes collation based on the items captured by the holding unit, and executes a predetermined processing based on the result. The present invention also provides methods of running the gift certificate issuing system and the gift certificate using system.

### BRIEF DESCRIPTION OF THE DRAWINGS

FIG. 1 is a block diagram showing a structure of a gift certificate issuing system and a gift certificate using system in accordance with an exemplary embodiment of the present invention.

FIG. 2 is a functional block diagram showing a structure of the gift certificate issuing system and the gift certificate using system of FIG. 1.

FIG. 3 is a flowchart of purchasing a gift certificate in the gift certificate issuing system in accordance with the exemplary embodiment.

FIG. 4 is a flowchart of using a gift certificate in the gift certificate using system in accordance with the exemplary embodiment.

FIG. 5 is a schematic diagram showing a using-condition setting screen in the gift certificate issuing system in accordance with the exemplary embodiment.

FIG. 6 is a schematic diagram showing a password-setting screen in the gift certificate issuing system in accordance with the exemplary embodiment.

FIG. 7 is a schematic diagram showing another password-setting screen in the gift certificate issuing system in accordance with the exemplary embodiment.

FIG. 8 is a schematic diagram showing a receiver's address setting screen in the gift certificate issuing system in accordance with the exemplary embodiment.

### DETAILED DESCRIPTION OF THE INVENTION

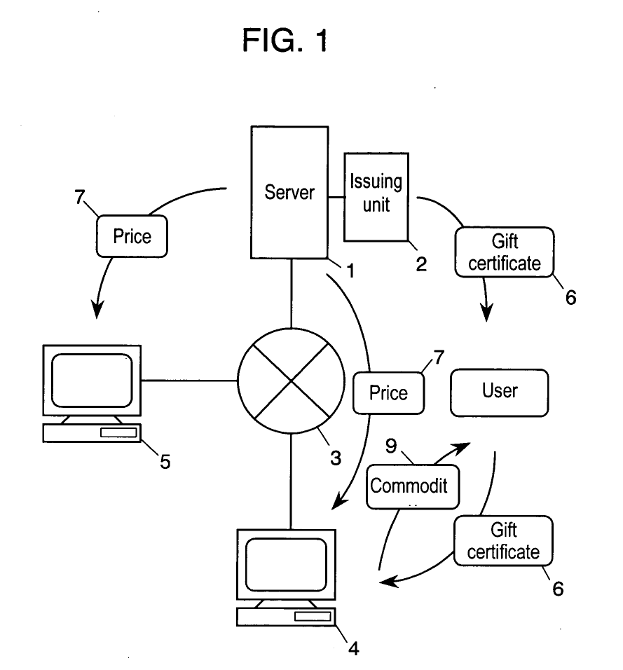

FIG. 1 is a block diagram showing a whole structure of a gift certificate, a gift certificate issuing system, and a gift certificate using system in accordance with an exemplary embodiment of the present invention.

Issuing unit 2 for outputting gift certificate 6 is connected to server 1. Terminal 4 for a store, and terminal 5 for a purchaser such as a personal computer or a mobile information device are connected to server 1 via network 3 such as the Internet.

A purchaser logs in to server 1 from terminal 5. Server 1 is a system managed by a gift certificate issuer. Server 1 displays a screen used for inputting items required for use of gift certificate 6 on terminal 5 of the purchaser. When the purchaser feeds the required items from terminal 5 into server 1, server 1 captures and holds the fed items. Server 1 then commands issuing unit 2 based on the captured items. A printer forming issuing unit 2 prints gift certificate 6 that has a gift certificate number (specific code) and no face value. The issuer sends gift certificate 6 to a user. The sending may be direct or indirect.

Issuing unit 2 may be formed of not the printer but an issuing machine of a magnetic card or an integrated circuit (IC) card. In this case, gift certificate 6 is a magnetic card or an IC card.

When the user brings gift certificate 6 to a store and finds desired commodity 9, the user shows both commodity 9 and gift certificate 6 to a store clerk (it is hereinafter called a clerk). The clerk logs in to server 1 using terminal 4. Server 1 displays the screen used for inputting the items required for use of gift certificate 6 on terminal 4. The clerk inputs the gift certificate number described on shown gift certificate 6 and the other required items. Server 1 collates the input items with corresponding information in server 1, and, when the collation result is correct, displays the fact on terminal 4. After checking the displayed contents, the clerk exchanges gift certificate 6 for the commodity 9. After the procedure, server 1 (issuer) executes the paying processing. In other words, server 1 pays price 7 of commodity 9 to the store and bills the purchaser for price 7.

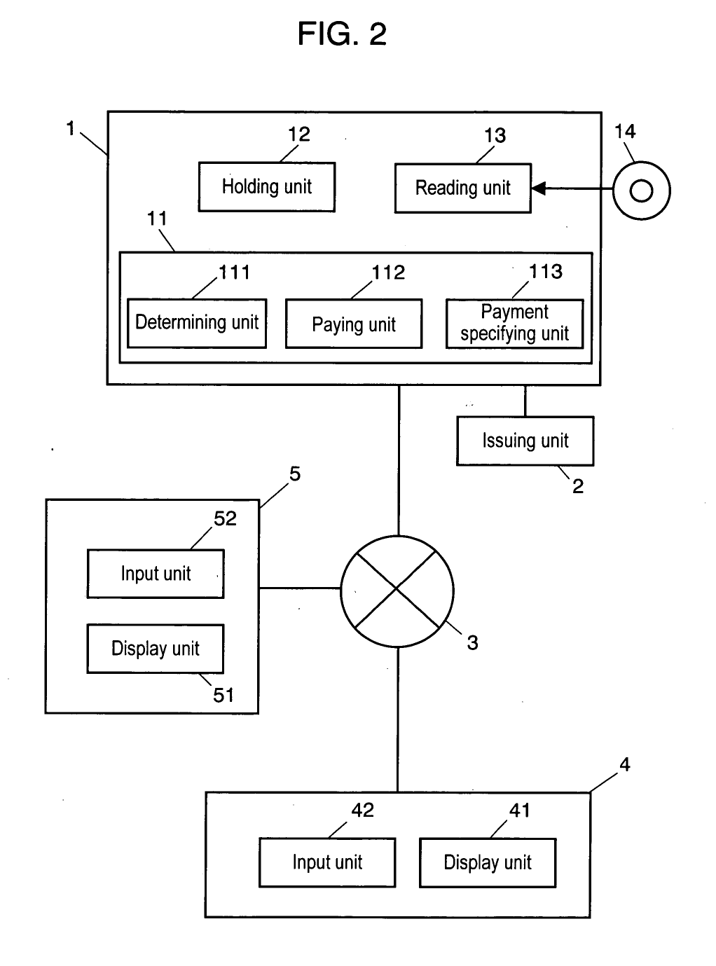

FIG. 2 is a functional block diagram showing a structure of the gift certificate issuing system and the gift certificate using system of FIG. 1. Server 1 has control unit 11, holding unit 12, and reading unit 13. Control unit 11 has determining unit 111, paying unit 112, and payment specifying unit 113. Terminals 4 and 5 have display units 41 and 51 and input units 42 and 52, respectively. Display units 41 and 51 are displays of a cathode ray tube (CRT) or liquid crystal, and input units 42 and 52 are keyboards or bar code readers. Control unit 11 is formed by installing a program into a general central processing unit (CPU) and a memory via recording medium 14 and reading unit 13. Holding unit 12 is a storing device or a recording device such as a memory device or a hard disk drive.

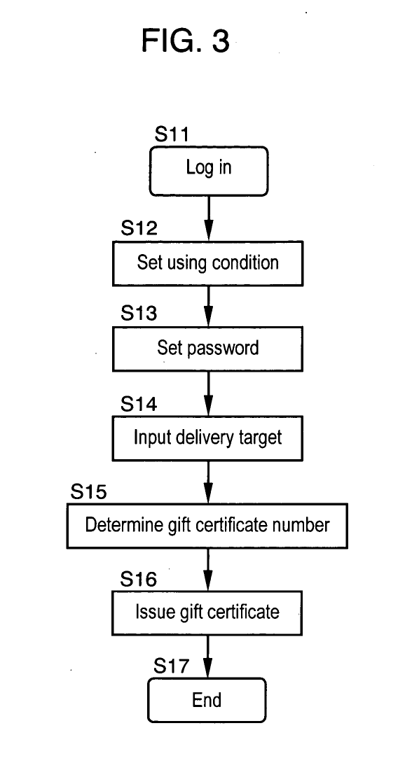

FIG. 3 is a flowchart showing a specific example where the gift certificate issuing system issues gift certificate 6 in accordance with the exemplary embodiment. A case where a purchaser presents a satchel to a child of a relative in celebration of the child's entrance into an elementary school is described.

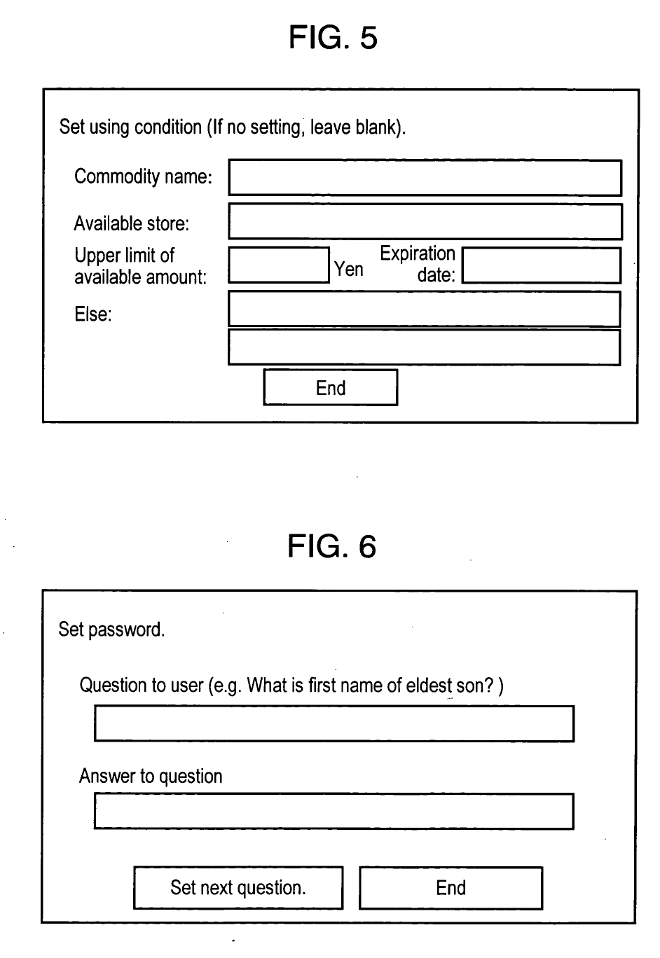

The purchaser logs in to server 1 from input unit 52 of terminal 5 (S11). The purchaser inputs his/her user identification (ID) and password at the log in time. Purchasing using a previously registered credit card is thus indicated as a default, and the paying method is specified. Server 1 has payment specifying unit 113. After the log in, the process goes to a using condition setting step (S12). In S12, a using condition for a gift certificate user is arbitrarily input. As shown in FIG. 5 for example, items “Commodity name”, “Available store”, “Upper limit of available amount” are prepared, and additionally, two kinds of items “Else” are prepared so as to allow arbitrary setting. The purchaser, after logging in, inputs “Satchel” as “Commodity name”, “Department store in ABC city (where the user lives)” as “Available store”, and “ ” (blank) as “Upper limit of available amount”, for example. Additionally, the purchaser inputs “April, 2004” as “Expiration date” (a satchel is required before the entrance), and “one specified by XY elementary school” as “Else”. After the inputting, the purchaser clicks “End”. Display unit 51 displays these items and input states of them.

After the using condition setting of S12, the process goes to password setting of S13. In S13, as shown in FIG. 6 for example, display unit 51 displays a screen where server 1 requests the purchaser to input a question to the user and an answer to the question. For example, “Birth date of eldest son? Input in eight-digit form (MM-DD-YYYY).” is shown as the question, and the purchaser inputs “05-21-1997” as the answer. When the purchaser simply desires that a password is input, the purchaser leaves the question field blank.

When the purchaser does not need to specify a plurality of questions and answers, he/she clicks “End”. For setting the other question, the purchaser clicks “Set next question”. The same screen then appears, and the purchaser sets next question and answer.

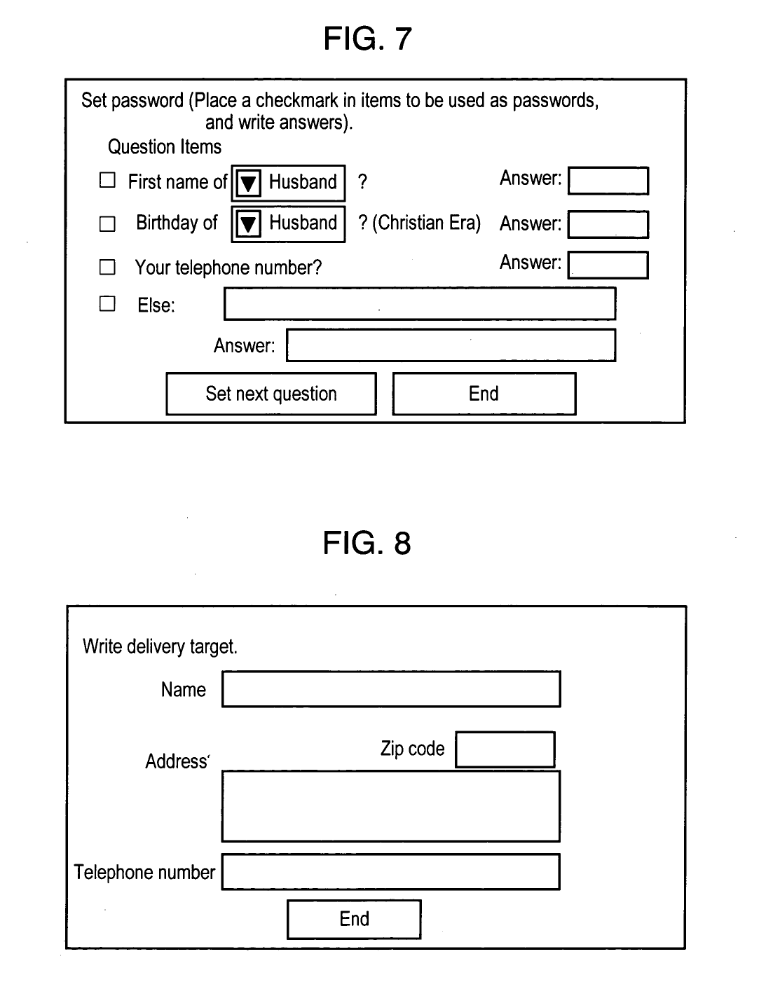

FIG. 7 shows a screen for setting the other password(s). Server 1 prepares standard questions, and the purchaser places a checkmark in a question item desired to be asked to the user. The checkmark may be placed in a plurality of items. A first name is asked in the first question item, but whose name to be input can be selected from a pull-down menu. In other words, “Husband” is displayed in this screen, but, on clicking the ▾ mark “Wife”, “Eldest son”, “Eldest daughter”, “Son”, and “Daughter” are displayed. The purchaser selects a suitable item and enters in an answer to the item. The next, birthday item is similar to the name item.

When standard question items are thus set, question items of the purchaser are prevented from falling into ambiguity. When a user inputs an answer to a question, difference between formats is prevented from causing mismatch of a password. For example, whether the user inputs “1-1-95” or “Jan. 1, 1995” as the birthday, control unit 11 of server 1 translates it into “01011995”.

The process then goes to S14. In S14, display unit 51 displays a screen used for specifying a delivery target of gift certificate 6. In FIG. 8, the purchaser inputs a receiver's name, address, and the like of the delivery target, and clicks “End”.

After the completion of the inputs, control unit 11 of server 1 determines a code to be printed in gift certificate 6, and issues gift certificate 6. Here, 16 digits are used as the code to be printed in gift certificate 6. Holding unit 12 of server 1 stores the contents which the purchaser inputs into server 1 via input unit 52 in S12 to S14 and the 16 digits. In the issuing process, the using condition input in S12 and the 16 digits are printed in gift certificate 6. Therefore, the user can recognize the using condition of gift certificate 6 without accessing the issuing system or the using system. Gift certificate 6 is sent to the delivery target specified in S14.

As discussed above, the purchaser decides an upper limit of available amount. In other words, a user can arbitrarily select a desired commodity without concerning the price of the commodity. However, for preventing a user from buying an unexpectedly expensive commodity or suppressing damage due to possible illegal use, it is preferable to set an upper limit of available amount and an expiration date by default.

The validity of gift certificate 6 can be judged by inquiring of a gift certificate issuing company (this is hereinafter called an issuer) about the specific code of gift certificate 6. The issuer can recognize a paying method based on the specific code, and can make a payment with the paying method concealed from persons except for the issuer. In the paying method by credit card, the payment can be made with the credit card number concealed from the user or a dealer of gift certificate 6.

In the paying method by credit card, the issuer can easily obtain credit information of the purchaser and can use an existing system for credit card payment, so that certain payment is allowed.

The purchaser inputs required items to terminal 5 by himself/herself in the discussion above; however, terminal 5 is installed in a store or the like and a store clerk may input them on behalf of the purchaser. The gift certificate number is set as 16 digits in the discussion above; however, characters such as alphabets or Katakanas other than digits may be used, or a symbol such as a bar code or a two-dimensional matrix-shaped bar code may be used. Further, data recorded in a recording medium such as a contact or non-contact magnetic card or IC card may be used.

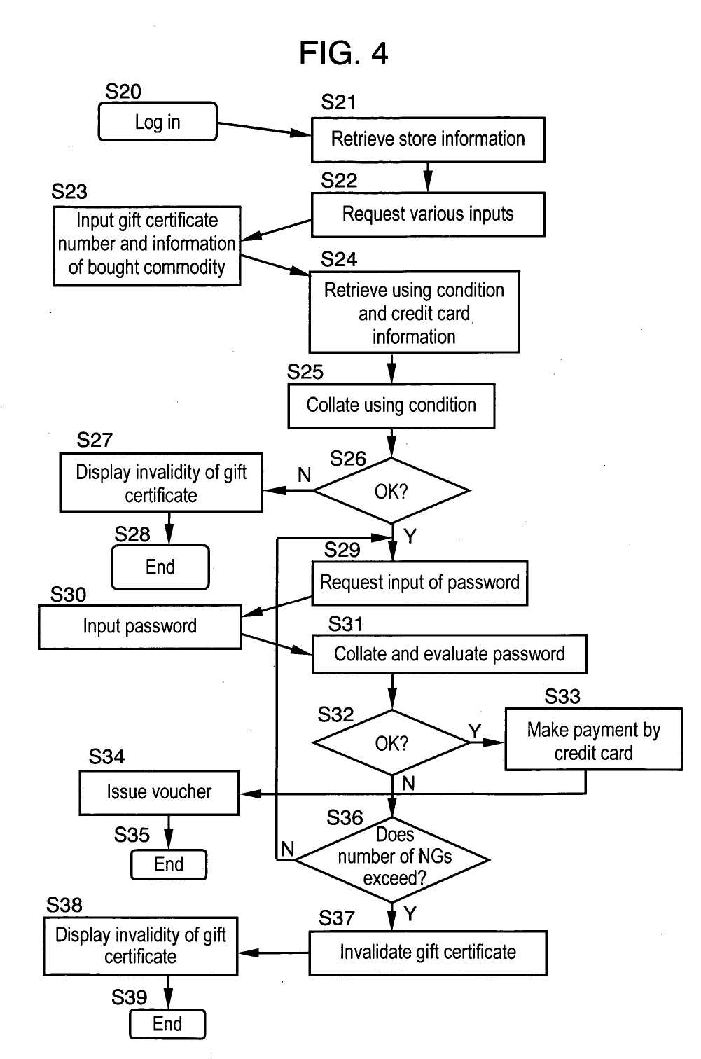

A user having received gift certificate 6 sent in these processes buys commodity 9 according to the contents entered in gift certificate 6. This system is a type of electronic banking system. A flowchart from then is described with reference to FIG. 4.

When the user goes to a store specified from the using condition and finds desired commodity 9, the user shows commodity 9 and gift certificate 6 to a clerk of the store. The clerk logs in from input unit 42 of terminal 4 connected to server 1. After the log-in, control unit 11 in server 1 retrieves and obtains, from holding unit 12, information of the store where the log-in is performed (S21). Control unit 11 then requests various inputs (S22). Here, control unit 11 requests input of a gift certificate number and information of the commodity to be brought. The clerk reads the gift certificate number from gift certificate 6, and inputs it from input unit 42. The clerk inputs the information of commodity 9 (S23). The commodity name, commodity number, and price may be automatically input by reading the bar code attached to the commodity with a bar code reader.

After the completion of the input by the clerk in S23, control unit 11 retrieves the using condition and the paying method stored in holding unit 12 based on the gift certificate number (S24). Determining unit 111 of control unit 11 collates the information and using condition of commodity 9 with the actual using state (S25), and determines whether or not matching is established (S26). When there is no matching, control unit 11 displays “You cannot buy this commodity with this gift certificate” on display unit 41 (S27), and logs out (S28). In this case, gift certificate 6 is still valid, so that another commodity matching with the using condition can be bought with gift certificate 6.

As discussed above, when gift certificate 6 is used, the items required for the use stored in holding unit 12 are collated with the actual using state, and the validity or the like of gift certificate 6 is determined. The using condition is mainly registered in holding unit 12 of server 1. Therefore, even if a user uses gift certificate 6 after the expiration date, server 1 rejects the acceptance and hence the store clerk does not need to feel embarrassed. Use unintended by the purchaser can be prevented.

While, when the matching is determined in S26, the process goes to S29 for requesting a password input. In S29, display unit 41 displays the questions set by the purchaser. Since the question, “Birth date of eldest son? Input in eight-digit form (MM-DD-YYYY).” is set by the purchaser, this question is displayed. The user inputs “05-21-1997” as the birth date of his/her eldest son from input unit 42 (S30). Determining unit 111 of control unit 11 in server 1 collates the stored contents with the input data (S31), and determines whether or not matching is established (S32). When an input password is not correct, control unit 11 requests another input once and again, and determines whether or not a correct password is input within a certain number of times (S36). Thus, the input contents are displayed in the question formation to the user on display unit 41. Matters that a user intended by the purchaser obviously knows are set as the question. The user can therefore answer correctly even when the purchaser does not previously inform the user of the password, so that an easy authentication is allowed.

When the correct password is not input within the certain number of times, control unit 11 determines that the user is an unauthorized user and invalidates gift certificate 6 (S37). In other words, gift certificate 6 cannot be used anymore. When the correct authentication is not performed, server 1 may inform the purchaser via display unit 41 (S38).

After the steps S29 to S32, the process finally goes to a paying process (S33) or the invalidating process (S37). When the determination result is “acceptable”, the paying process is performed. When the determination result is “unacceptable”, the gift certificate is invalidated. Illegal use of the gift certificate is therefore prevented, and a desired commodity can be speedily provided to the user.

When the inputs are correct, the process goes to the paying process (S33) and the user receives commodity 9. After that, a voucher is issued in S34, and the process is terminated in S35. In S33, server 1 has already obtained the store information at the log-in time in S21. Since the information about the commodity has been input in S23, the price of the commodity is recognized. Since the gift certificate number has been similarly input in S23, who pays for the bought commodity and how to pay are recognized. Paying unit 112 of control unit 11 in server 1 certainly bills the purchaser of gift certificate 6 for the price of commodity 9, and certainly transfers the price into the account of the store where gift certificate 6 is used.

The paying method specified by payment specifying unit 113 is recognized from the specific code of gift certificate 6, so that a paying method does not need to be newly input. Therefore, risk of leakage of the information related to the payment such as credit card number is reduced, and the issuer can certainly pay for used gift certificate 6.

Holding unit 12 holds the set password and expiration date. Therefore, even if gift certificate 6 becomes lost, use of gift certificate 6 is prevented when input contents do not match with the previously held contents, and illegal use can be prevented. Holding unit 12 holds the using condition of gift certificate 6, so that indiscriminate use of gift certificate 6 is prevented.

As discussed above, holding unit 12 holds at least one of the specific code entered in gift certificate 6, the information of a desired commodity, and the password. Therefore, by inputting the specific code, the using condition and paying method of gift certificate 6 can be identified. By inputting the information of a desired commodity, it is determined whether or not the commodity matches with the buying condition. By inputting a password, it can be confirmed that the user is a person intended by the purchaser.

The payment is made by credit card in the present embodiment; however, another paying method may be input from terminal 5 and stored in holding unit 12. This structure allows a purchaser to arbitrarily set a paying method.

The case that a commodity is bought is described above; however, a gift certificate may be set as a dinner ticket or a accommodation coupon that has no face value and has a using condition such as “Two persons, at KL restaurant in MN hotel”. Gift certificates may have various types: a normal gift certificate printed on paper, a prepaid card such as a calling card, an IC card, an electronic money, and a coupon ticket often used in a hotel or the like. A gift certificate may be also “a throwaway credit card”.

When a server on the Internet is employed as server 1, access from a mobile phone is allowed.

Gift certificate 6 is described as a physically distributed matter, but may be used in a system for performing issuing, using, and paying on a network. In this case, gift certificate 6 may be an electronic mail or an attached file having a specific code. An available store may be a site on the Internet.

The present invention allows certain and safe payment while securing a degree of freedom of a using target or an available amount. Even when no face value is entered in a gift certificate, just after the gift certificate was used, a store that sells a commodity can certainly bill a purchaser (issuer) of the gift certificate for the price. Since no face value is entered in the gift certificate, the user does not need to concern the price of the commodity and the use of the gift certificate is not essentially restricted.

What is claimed is:

1. A gift certificate comprising a specific code for indicating at least a paying method instead of a face value.

2. A gift certificate according to claim 1, wherein the paying method is performed with a credit card possessed by a purchaser of the gift certificate.

3. A gift certificate according to claim 1, wherein a using condition is entered in the gift certificate.

4. A gift certificate issuing system comprising:
a first display unit for displaying a screen used for inputting an item, the item being required for use of a gift certificate;
a first input unit for receiving an input of the item based on the screen by the first display unit;
a holding unit for capturing the item fed into the first input unit; and
an issuing unit for issuing the gift certificate having a specific code for indicating at least a paying method instead of a face value, based on the item captured into the holding unit.

5. A gift certificate issuing system according to claim 4, further comprising a payment specifying unit based on the item captured into the holding unit.

6. A gift certificate issuing system according to claim 4, wherein the item includes at least one of a using condition in using the gift certificate, a password input in using the gift certificate, and a paying method of the gift certificate.

7. A gift certificate issuing system according to claim 4, wherein the holding unit stores the specific code.

8. A gift certificate issuing system according to claim 4, wherein the issuing unit enters a using condition in the gift certificate.

9. A gift certificate using system comprising:
a second display unit for displaying a screen used for inputting an item, the item being required for use of a gift certificate;
a second input unit for receiving an input of the item based on the screen by the second display unit;
a holding unit for capturing the item fed into the second input unit; and
a paying unit for executing a collation based on the item captured by the holding unit and then executing a predetermined processing based on a collation result.

10. A gift certificate using system according to claim 9, wherein the item includes at least one of a specific code entered in the gift certificate, information of a desired commodity, and a password.

11. A gift certificate using system according to claim 9, wherein the item is displayed in a question form on the second display unit.

12. A gift certificate using system according to claim 9, wherein the processing executed by the paying unit includes at least one of a predetermined paying processing and an invalidating processing of the gift certificate.

13. A gift certificate issuing method comprising the steps of:
displaying a screen used for inputting an item, the item being required for use of a gift certificate;
receiving an input of the item based on the screen;
capturing the input item; and
issuing a gift certificate having a specific code for indicating at least a paying method instead of a face value based on the captured item.

14. A gift certificate using method comprising the steps of:
displaying a screen used for inputting an item, the item being required for use of a gift certificate;
receiving an input of the item based on the screen;
capturing the input item; and
executing a collation based on the captured item and then executing a predetermined processing based on a collation result.

15. A computer program product for issuing a gift certificate comprising the steps of:
displaying a screen used for inputting an item, the item being required for use of a gift certificate;
receiving an input of the item based on the screen;
capturing the input item; and
issuing a gift certificate having a specific code for indicating at least a paying method instead of a face value based on the captured item.

16. A computer program product for using a gift certificate comprising the steps of:
displaying a screen used for inputting an item, the item being required for use of a gift certificate;
receiving an input of the item based on the screen;
capturing the input item; and
executing a collation based on the captured item and then executing a predetermined processing based on a collation result.
